(19) United States
(12) Patent Application Publication
(10) Pub. No.: US 2015/0364825 A1
(43) Pub. Date: Dec. 17, 2015

(54) DUAL-BAND THREE-DIMENSIONAL ANTENNA

(71) Applicant: ARCADYAN TECHNOLOGY CORPORATION, Hsinchu City (TW)

(72) Inventor: JING-TENG CHANG, Hsinchu County (TW)

(21) Appl. No.: 14/325,819

(22) Filed: Jul. 8, 2014

(30) Foreign Application Priority Data
Jun. 16, 2014 (TW) 103120748

(51) Int. Cl. H01Q 9/04; H01Q 5/371

(52) U.S. Cl. CPC H01Q 9/0414; H01Q 5/371

(57) ABSTRACT

A dual-band three-dimensional (3D) antenna is disclosed, which comprises: a first radiation unit; a resonant extension unit, being disposed not on the same plane with the first radiation unit; a feeder unit, coupled to the first radiation unit while allowing an opening to be formed at a position between the feeder unit and the first radiation unit; a connection unit, coupled to a substrate and the feeder unit while allowing an obliquely extending unit to be formed at a position between the connection unit and the feeder unit; and a second radiation unit, coupled to the resonant extension unit.

### FIELD OF THE INVENTION

The present invention relates to a dual-band three-dimensional (3D) antenna, and more particularly, to a small dual-band three-dimensional (3D) antenna designed not only for allowing its operation frequency to be varied and fine-toned according to different minute structural changes adopted in its various embodiments, but also enabling the size of the dual-band three-dimensional (3D) antenna to be reduced while preventing shortcomings of other conventional 3D antennas.

### BACKGROUND OF THE INVENTION

In the modern era of rapidly developing technology, it is in need of a smartly designed antenna with good transceiving ability that is effectively enough to be embedded in all kinds of modern handheld or portable electronic devices for wireless communication. Moreover, in response to the rapidly increasing types of electronic communication devices that are being made smaller and smaller and becoming available everyday, it is generally required to develop new antennas or antennas made of new materials that are to be embedded in various small handheld electronic devices or external wireless transmission devices, such as cellular phones, notebook computers, access points (APs) and card buses.

There are generally two types of antennas used on common electronic communication devices, which are planar antenna and three-dimensional (3D) antenna. Although both types of antennas are capable of transceiving signals of electromagnetic field wave, the efficiency of the 3D antenna is generally better since 3D antennas can be more efficient in the receiving of signals from vertical antennas of a base station while the receiving of planar antennas can easily be shielded by circuit components disposed surrounding thereof for enabling its receiving ability to be aversely affected.

In addition, comparing to the single horizontal current direction of the planar antenna, the 3D antenna is designed with vertical current direction and horizontal current direction which enables the 3D antenna to have better electromagnetic compatibility and lower electromagnetic interference.

Nevertheless, since conventionally 3D antennas are generally larger by design, the space available in those modern mobile communication devices that are being built smaller and smaller may not be sufficient enough for accommodating the 3D antennas. And what's even worse, that as today's standard antennas should be able to operate in more than two frequency bands, it is comparatively more difficult for designing a 3D multi-band antenna, but it is an essential problem required to be resolved.

### SUMMARY OF THE INVENTION

In view of the disadvantages of prior art, the primary object of the present invention is to provide to a dual-band three-dimensional (3D) antenna, and more particularly, to a small dual-band three-dimensional (3D) antenna designed not only for allowing its operation frequency to be varied and fine-toned according to different minute structural changes adopted in its various embodiments, but also enabling the size of the dual-band three-dimensional (3D) antenna to be reduced while preventing shortcomings of other conventional 3D antennas.

To achieve the above object, the present invention provides a dual-band 3D antenna, which comprises:

a first radiation unit, formed with a first bending part;

a feeder unit, coupled to the first radiation unit while allowing an opening to be formed at a position between the feeder unit and the first radiation unit;

a resonant extension unit, coupled to the feeder unit while allowing the resonant extension unit not to be disposed on the same plane with the first radiation unit;

an obliquely extending unit, having a first end and a second end that are arranged corresponding to each other while allowing the first end to couple to a substrate that is disposed not on the same plane with the obliquely extending unit for allowing an acute angle to be formed between the obliquely extending unit and the substrate; and for enabling the second end to be arranged neighboring to the resonant extension unit and coupling to the feeder unit while allowing the obliquely extending unit to be arranged on the same plane with a specific portion of the feeder unit;

wherein, the first radiation unit is defined to operate at a first radiation frequency;

the resonant extending unit is defined to operate at a second radiation frequency;

and the first radiation frequency is larger than the second radiation frequency.

Preferably, the dual-band 3D antenna further comprises: a second radiation unit, formed with a second bending part while coupling to an end of the resonant extension unit that is disposed away from the first radiation unit.

Preferably, the second radiation unit is not disposed on the same plane with the resonant extension unit.

Preferably, the second radiation unit is arranged in a manner selected from the group consisting of: the second radiation unit is attached to the substrate, and the second radiation unit is not attached to the substrate.

Preferably, the resonant extension unit and the second radiation unit are defined to operate cooperatively at the second radiation frequency.

Preferably, each of the first radiation unit, the feeder unit, the resonant extension unit, the obliquely extending unit and the second radiation unit is formed as a sheet structure.

Preferably, the dual-band 3D antenna further comprises: a connection part, being arranged at an end of the oblique extending unit, but not on the same plane with the obliquely extending unit, while coupling to the substrate.

Preferably, the connection part is coupled to a ground region of the substrate.

Preferably, the feeder unit is coupled to a signal feed-in region of the substrate.

Preferably, a portion of the feeder unit is disposed on the same plane with a specific portion of the first radiation unit.

Preferably, the first radiation unit is arranged in a manner selected from the group consisting of: the first radiation unit is attached to the substrate, and the first radiation unit is not attached to the substrate.

Preferably, the first radiation unit is further formed with a third bending part, and the portion of the first radiation portion that is extending after the third bending part is arranged extending in a direction perpendicular to the substrate or parallel to the substrate.

Preferably, the portion of the second radiation unit after the coupling with the resonant extension unit is extending in a direction perpendicular to the substrate, while enabling the portion of the second radiation unit that is extending after the second bending part to extend in a direction parallel to the substrate.

Preferably, the second radiation unit is disposed in a manner selected from the group consisting of: the second radiation unit is disposed on the same plane with the obliquely extending unit, and the second radiation unit is not disposed on the same plane with the obliquely extending unit, while allowing the portion of second radiation unit that is extending after the second bending part to extend in a direction parallel to the substrate.

Preferably, the resonant extension unit is further formed with a tongue plate that is disposed extending at a position between the first end and the second end.

Preferably, the feeder unit is enabled to perform a feeding operation via a device selected from the group consisting of: a coaxial cable, a micro strip, a coplanar waveguide transmission line.

Preferably, the dual-band 3D antenna of the present invention is an integrally formed metal structure.

Further scope of applicability of the present application will become more apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention and wherein:

FIG. 1A and FIG. 1B are schematic diagrams showing a small dual-band 3D antenna according to a first embodiment of the present invention.

FIG. 2A and FIG. 2B are schematic diagrams showing a small dual-band 3D antenna according to a second embodiment of the present invention.

FIG. 3A and FIG. 3B are schematic diagrams showing a small dual-band 3D antenna according to a third embodiment of the present invention.

FIG. 4A and FIG. 4B are schematic diagrams showing a small dual-band 3D antenna according to a fourth embodiment of the present invention.

FIG. 5A and FIG. 5B are schematic diagrams showing a small dual-band 3D antenna according to a fifth embodiment of the present invention.

FIG. 6 is a schematic diagram showing a small dual-band 3D antenna according to a sixth embodiment of the present invention.

FIG. 7 is a schematic diagram showing a small dual-band 3D antenna according to a seventh embodiment of the present invention.

FIG. 8 is a schematic diagram showing a small dual-band 3D antenna according to an eighth embodiment of the present invention.

### DESCRIPTION OF THE EXEMPLARY EMBODIMENTS

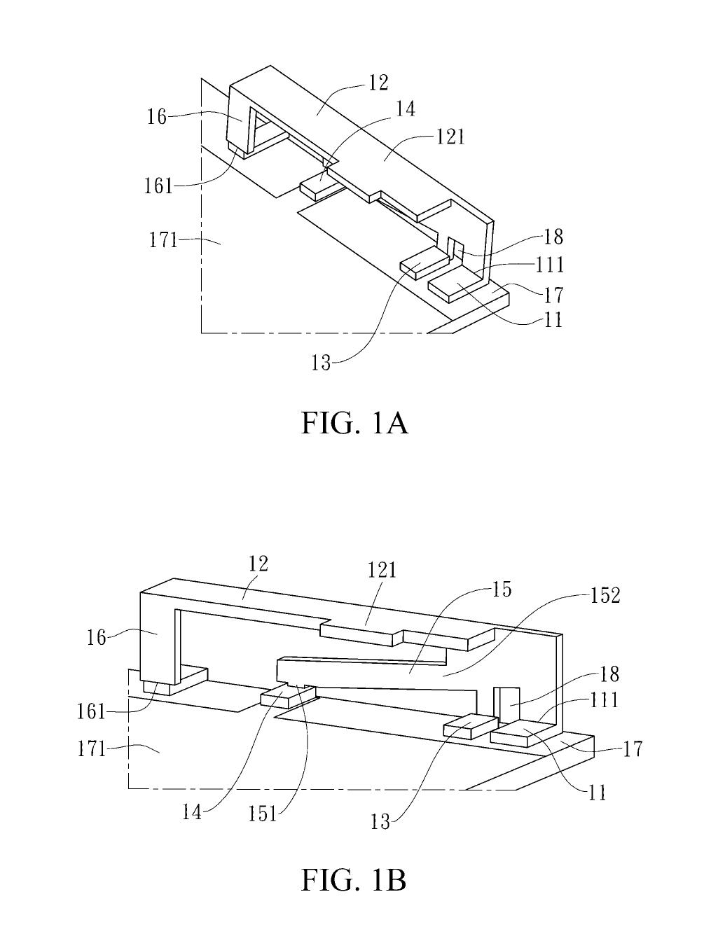

For your esteemed members of reviewing committee to further understand and recognize the fulfilled functions and structural characteristics of the invention, several exemplary embodiments cooperating with detailed description are presented as the follows.
Please refer to FIG. 1A and FIG. 1B, which are schematic diagrams showing a small dual-band 3D antenna according to a first embodiment of the present invention. In FIG. 1A and FIG. 1B, a small dual-band 3D antenna is disclosed, which comprises: a first radiation unit 11, being formed as a sheet structure, but not limited thereby only if it is a metal object capable of radiating signals, and formed with a first bending part 111; a feeder unit 13, being formed as the sheet structure, but also not limited thereby, and disposed coupling to the first radiation unit 11 while allowing an opening 18 to be formed at a position between the feeder unit 13 and the first radiation unit 11, and enabling the feeder unit 13 to perform a feeding operation via a coplanar waveguide (CPW) transmission structure; a resonant extension unit 12, being formed as the sheet structure and coupled to the feeder unit 13 while allowing the resonant extension unit 12 not to be disposed on the same plane with the first radiation unit 11; an obliquely extending unit 15, being formed as a sheet structure, and having a first end 151 and a second end 152 that are arranged corresponding to each other while allowing the first end 151 to couple to a substrate 17 that is disposed not on the same plane with the obliquely extending unit 15 for allowing an acute angle to be formed between the obliquely extending unit 15 and the substrate 17, and for enabling the second end 152 to be arranged neighboring to the resonant extension unit 12 and coupling to the feeder unit 13 while allowing the coupling portion 14 of the obliquely extending unit 15 to be arranged on the same plane with the feeder unit 13 in a manner that the obliquely extending unit 15 is coupled to a ground region 1741 of the substrate 17 and the feeder unit 13 is coupled to a signal feed-in region of the substrate 17; and a second radiation unit 16, being formed as the sheet structure and formed with a second bending part 161 coupling to an end of the resonant extension unit 12 that is disposed away from the first radiation unit 11 while allowing the second radiation unit 16 to be disposed not one the same plane with the resonant extension unit 12; wherein, the first radiation unit 11 is defined to operate at a first radiation frequency; the resonant extending unit 12 and the second radiation unit 16 are defined to operate cooperatively at a second radiation frequency; and the first radiation frequency is larger than the second radiation frequency.

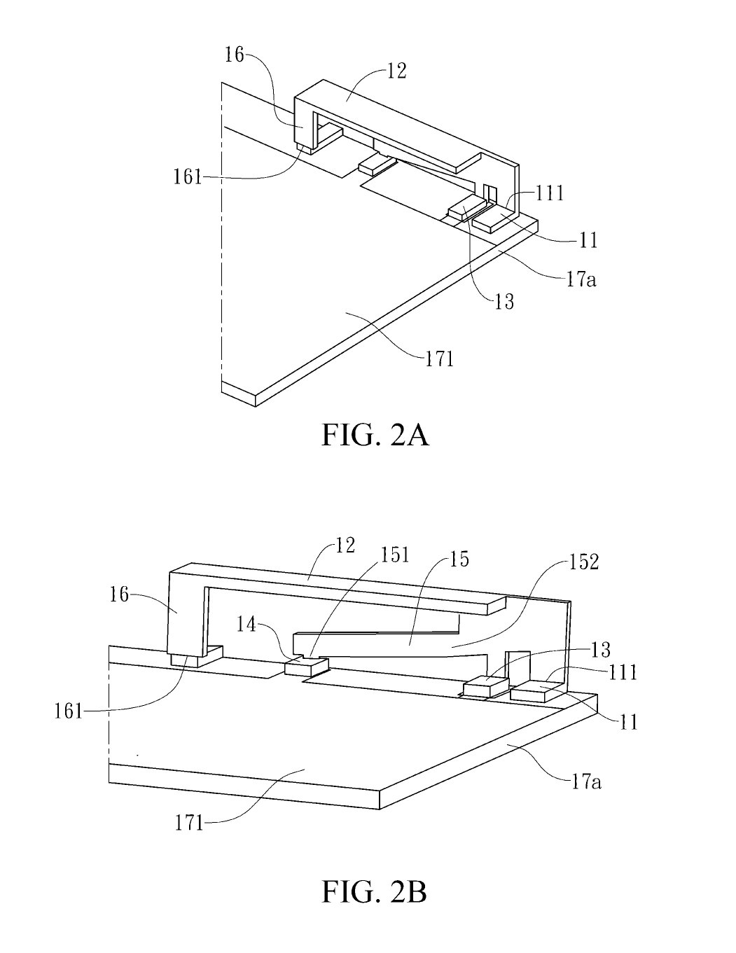

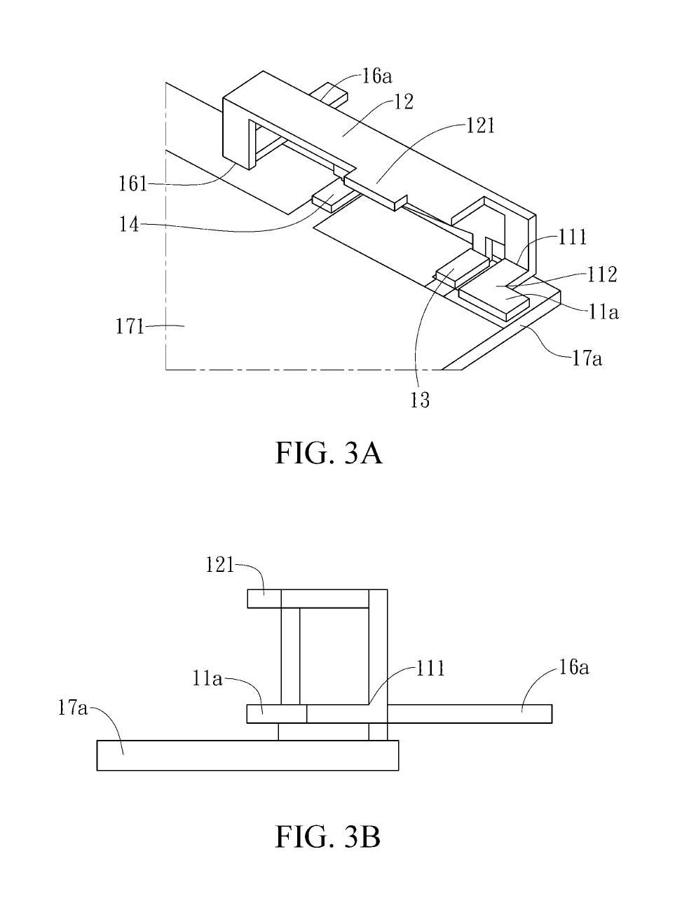

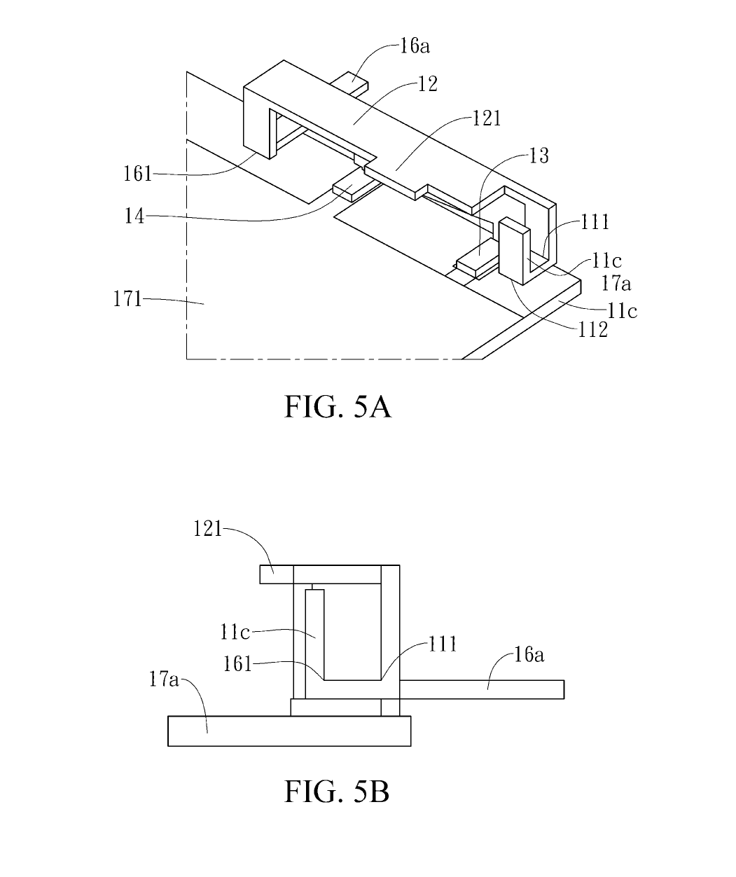

For fine-tuning resonant frequency, the structure of the dual-band 3D antenna can be adjusted and varied in many ways, that are shown in the following embodiments detailed in FIG. 2A to FIG. 8. For instance, a specific portion of the feeder unit 13 can be disposed on the same plane with a specific portion of the first radiation unit 11; each of the first radiation unit 11 and the second radiation unit 16 is arranged in a manner selected from the group consisting of: it is attached to the substrate 17, and it is not attached to the substrate 17; the portion of the first radiation unit 11 after the coupling with the feeder unit 13 is extending in a direction perpendicular to the substrate 17, while enabling the portion of the first radiation unit 11 that is extending after the first bending part 111 to extend in a direction parallel to the substrate 17; the first radiation unit 11 is further formed with a third bending part 112, as shown in FIG. 3A, FIG. 3B, FIG. 5A and FIG. 5B, and the portion of the first radiation portion 11 that is extending after the third bending part 112 is arranged extending in a direction perpendicular to the substrate 17 or parallel to the substrate 17; the second radiation unit 16 is arranged either on the same plane or not on the same plane with the obliquely extending unit 15; the resonant extension unit 12 is further formed with a tongue plate 121 that is disposed extending at a position between the first end 151 and the second end 152.

Please refer to FIG. 2A and FIG. 2B are schematic diagrams showing a small dual-band 3D antenna according to a second embodiment of the present invention. The difference between this second embodiment with the first embodiment is that: the ground region 171 of the substrate 17a is formed extending to a feed-in point 13 for coupling, and there is no tongue plate formed on the resonant extension unit 12, and consequently by the minute structural changes in the second embodiment, the specifications of the resulting dual-band 3D antenna relating to impedance, bandwidth and standing wave ratio (SWR) can be changed.

Please refer to FIG. 3A and FIG. 3B are schematic diagrams showing a small dual-band 3D antenna according to a third embodiment of the present invention. The difference between this third embodiment with the second embodiment is that: the first radiation unit 11a is not attached to the substrate 17a, and is further formed with a third bending part 112 in a manner that the first radiation unit 11a is bended to turn in a direction for enabling the extending of the first radiation unit 11a after the bending to parallel to the extending of the substrate 17a; and the resonant extension unit 12 has a tongue plate 121, while the portion of the second radiation unit 16a that is arranged extending in a direction parallel to the extending of the substrate 17 is longer than those disclosed in the embodiment of FIG. 2A and FIG. 2B. Similarly, by the minute structural changes in the third embodiment, the specifications of the resulting dual-band 3D antenna relating to impedance, bandwidth and standing wave ratio (SWR) can be changed.

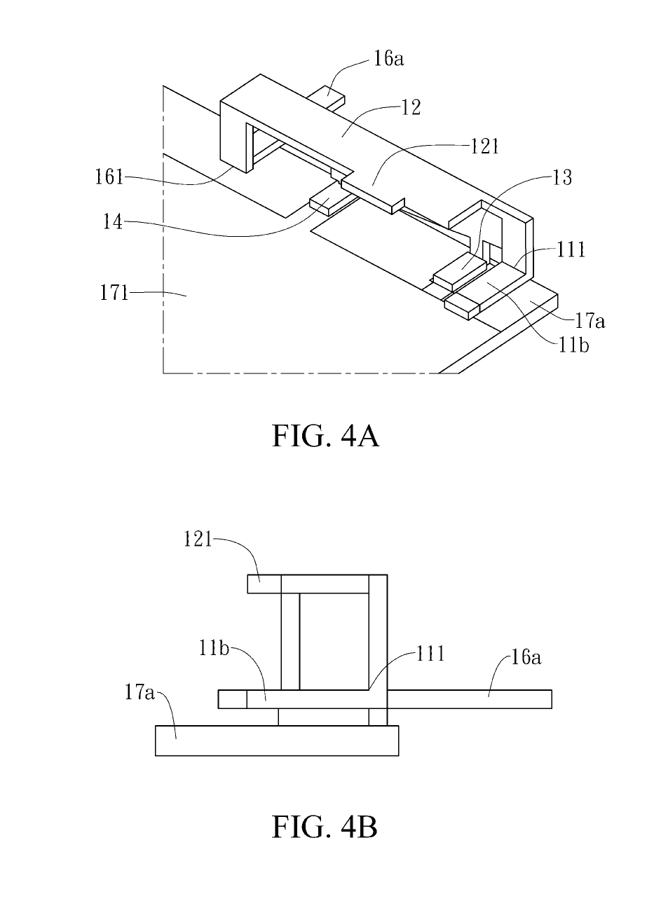

Please refer to FIG. 4A and FIG. 4B are schematic diagrams showing a small dual-band 3D antenna according to a fourth embodiment of the present invention. The difference between this fourth embodiment with the third embodiment is that: the first radiation unit 11b that is arranged not attaching to the substrate is formed as a straight plate that is extending longer than those disclosed in FIG. 1A and FIG. 1B. Similarly, by the minute structural changes in the fourth embodiment, the specifications of the resulting dual-band 3D antenna relating to impedance, bandwidth and standing wave ratio (SWR) can be changed.

Please refer to FIG. 5A and FIG. 5B are schematic diagrams showing a small dual-band 3D antenna according to a fifth embodiment of the present invention. The difference between this fifth embodiment with the fourth embodiment is that: the first radiation unit 11c that is arranged not attaching to the substrate 17a is further formed with a third bending part 112 in a manner that the first radiation unit 11c is bended to turn at the third bending part 112 in a direction for enabling the extending of the first radiation unit 11c after the bending to be arranged perpendicular to the extending of the substrate 17a. Similarly, by the minute structural changes in the fifth embodiment, the specifications of the resulting dual-band 3D antenna relating to impedance, bandwidth and standing wave ratio (SWR) can be changed.

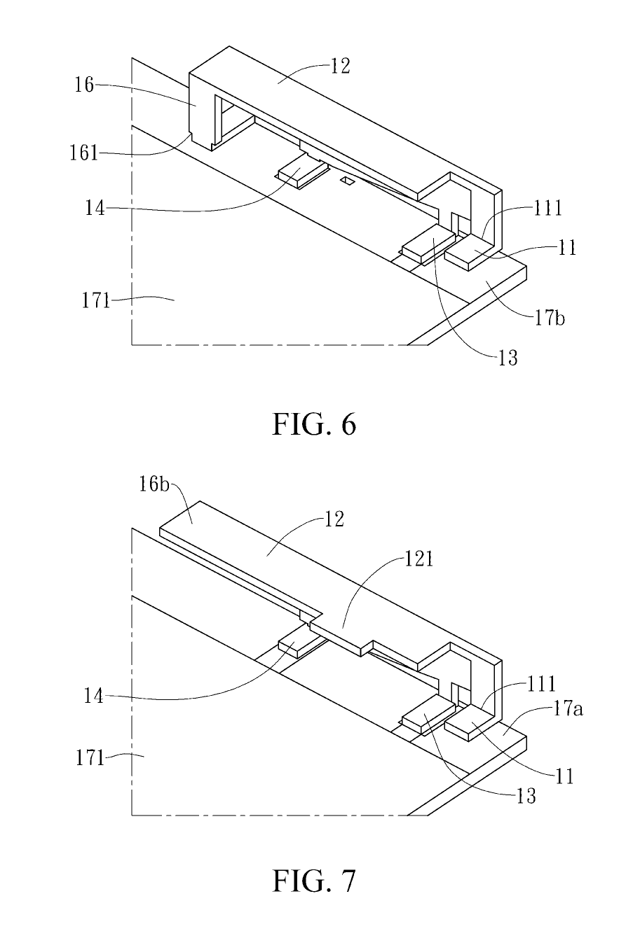

Please refer to FIG. 6, which is a schematic diagram showing a small dual-band 3D antenna according to a sixth embodiment of the present invention. The difference between this sixth embodiment with the first embodiment is that: the coupling portion 14 is not coupled to the ground region 171 of the substrate 17b, but instead the feeder unit 13 is coupled to the ground region 171 of the substrate 17b; and there is no tongue plate formed on the resonant extension unit 12. Similarly, by the minute structural changes in the sixth embodiment, the specifications of the resulting dual-band 3D antenna relating to impedance, bandwidth and standing wave ratio (SWR) can be changed.

Please refer to FIG. 7, which is a schematic diagram showing a small dual-band 3D antenna according to a seventh embodiment of the present invention. The difference between this seventh embodiment with the second embodiment is that: the second resonant unit 16b is formed without any bending, and is disposed on the same plane with the resonant extension unit 12 while extending in a direction parallel to the substrate 17a; and there is a tongue plate 121 formed on the resonant extension unit 12. Similarly, by the minute structural changes in the seventh embodiment, the specifications of the resulting dual-band 3D antenna relating to impedance, bandwidth and standing wave ratio (SWR) can be changed.

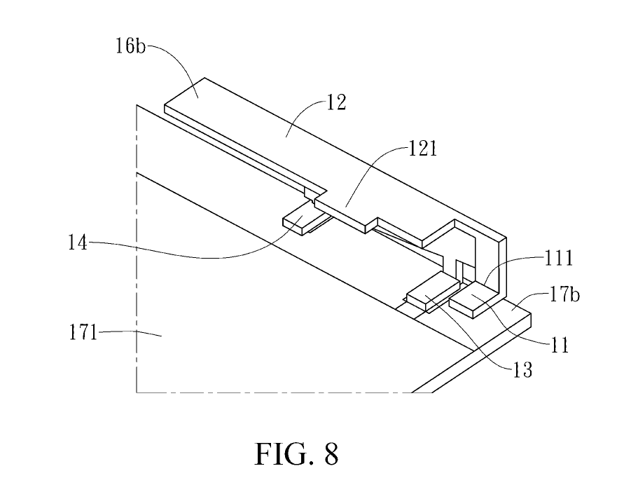

Please refer to FIG. 8, which is a schematic diagram showing a small dual-band 3D antenna according to an eighth embodiment of the present invention. The difference between this eighth embodiment with the sixth embodiment is that: the second resonant unit 16b is formed without any bending, and is disposed on the same plane with the resonant extension unit 12; and there is a tongue plate 121 formed on the resonant extension unit 12.

From the above embodiments shown in FIG. 1A to FIG. 8, it is noted that the present invention relates to a dual-band three-dimensional (3D) antenna, and more particularly, to a small dual-band three-dimensional (3D) antenna designed not only for allowing its operation frequency to be varied and fine-toned according to different minute structural changes adopted in its various embodiments, but also enabling the size of the dual-band three-dimensional (3D) antenna to be reduced while preventing shortcomings of other conventional 3D antennas.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

What is claimed is:

1. A dual-band three-dimensional antenna, comprising:
a first radiation unit, being formed as a sheet structure and formed with a first bending part;
a feeder unit, being formed as the sheet structure and disposed coupling to the first radiation unit while allowing an opening to be formed at a position between the feeder unit and the first radiation unit;
a resonant extension unit, being formed as the sheet structure and coupled to the feeder unit while allowing the resonant extension unit not to be disposed on the same plane with the first radiation unit;
an obliquely extending unit, having a first end and a second end that are arranged corresponding to each other while allowing the first end to couple to a substrate that is disposed not on the same plane with the obliquely extending unit for allowing an acute angle to be formed between the obliquely extending unit and the substrate, and for enabling the second end to be arranged neighboring to the resonant extension unit and coupling to the feeder unit while allowing the coupling portion of the obliquely extending unit to be arranged on the same plane with the feeder unit; and
a second radiation unit, being formed as the sheet structure and formed with a second bending part coupling to an end of the resonant extension unit that is disposed away from the first radiation unit while allowing the second radiation unit to be disposed not one the same plane with the resonant extension unit;
wherein, the first radiation unit is defined to operate at a first radiation frequency; the resonant extending unit and the second radiation unit are defined to operate cooperatively at a second radiation frequency; and the first radiation frequency is larger than the second radiation frequency.

2. The dual-band three-dimensional antenna of claim 1, wherein the obliquely extending unit is coupled to a ground region of the substrate, while the feeder unit is coupled to a signal feed-in region of the substrate.

3. The dual-band three-dimensional antenna of claim 1, wherein a portion of the feeder unit is disposed on the same plane with a specific portion of the first radiation unit.

4. The dual-band three-dimensional antenna of claim 1, wherein each of the first radiation unit and the second radiation unit is arranged in a manner selected from the group consisting of: it is attached to the substrate, and it is not attached to the substrate.

5. The dual-band three-dimensional antenna of claim 1, wherein the portion of the first radiation unit after the coupling with the feeder unit is extending in a direction perpendicular to the substrate, while enabling the portion of the first radiation unit that is extending after the first bending part to extend in a direction parallel to the substrate.

6. The dual-band three-dimensional antenna of claim 5, wherein the first radiation unit is further formed with a third bending part, and the portion of the first radiation portion that is extending after the third bending part is arranged extending in a direction perpendicular to the substrate or parallel to the substrate.

7. The dual-band three-dimensional antenna of claim 1, wherein the portion of the second radiation unit after the coupling with the resonant extension unit is extending in a direction perpendicular to the substrate, while enabling the portion of the second radiation unit that is extending after the second bending part to extend in a direction parallel to the substrate.

8. The dual-band three-dimensional antenna of claim 1, wherein the second radiation unit is disposed in a manner selected from the group consisting of: the second radiation unit is disposed on the same plane with the obliquely extending unit, and the second radiation unit is not disposed on the same plane with the obliquely extending unit.

9. The dual-band three-dimensional antenna of claim 1, wherein the resonant extension unit is further formed with a tongue plate that is disposed extending at a position between the first end and the second end.

10. The dual-band three-dimensional antenna of claim 1, wherein each of the first radiation unit, the feeder unit, the resonant extension unit, the obliquely extending unit and the second radiation unit is an integrally formed metal structure.

11. A dual-band three-dimensional antenna, comprising:
a first radiation unit, formed with a first bending part;
a feeder unit, disposed coupling to the first radiation unit by an end thereof while allowing another end thereof to couple to a signal feed-in region of a substrate and allowing an opening to be formed at a position between the feeder unit and the first radiation unit;
a resonant extension unit, coupled to the feeder unit while allowing the resonant extension unit not to be disposed on the same plane with the first radiation unit; and
an obliquely extending unit, having a first end and a second end that are arranged corresponding to each other while allowing the first end to couple to a ground region of the substrate that is disposed not on the same plane with the obliquely extending unit for allowing an acute angle to be formed between the obliquely extending unit and the substrate, and for enabling the second end to be arranged neighboring to the resonant extension unit and coupling to the feeder unit while allowing the coupling portion of the obliquely extending unit to be arranged on the same plane with the feeder unit;
wherein, the first radiation unit is defined to operate at a first radiation frequency; the resonant extending unit is defined to operate cooperatively at a second radiation frequency; and the first radiation frequency is larger than the second radiation frequency.

12. The dual-band three-dimensional antenna of claim 11, further comprising:
a second radiation unit, formed with a second bending part, and coupling to an end of the resonant extension unit that is disposed away from the first radiation unit while allowing the second radiation unit to be disposed not on the same plane with the resonant extension unit.

13. The dual-band three-dimensional antenna of claim 12, wherein the portion of the second radiation unit after the coupling with the resonant extension unit is extending in a direction perpendicular to the substrate, while enabling the portion of the second radiation unit that is extending after the second bending part to extend in a direction parallel to the substrate.

14. The dual-band three-dimensional antenna of claim 12, wherein the resonant extending unit and the second radiation unit are defined to operate cooperatively at the second radiation frequency

15. The dual-band three-dimensional antenna of claim 11, wherein ach of the first radiation unit and the second radiation unit is arranged in a manner selected from the group consisting of: it is attached to the substrate, and it is not attached to the substrate.

16. The dual-band three-dimensional antenna of claim 11, wherein the portion of the first radiation unit after the coupling with the feeder unit is extending in a direction perpendicular to the substrate, while enabling the portion of the first radiation unit that is extending after the first bending part to extend in a direction parallel to the substrate.

17. The dual-band three-dimensional antenna of claim 16, wherein the first radiation unit is further formed with a third bending part, and the portion of the first radiation portion that is extending after the third bending part is arranged extending in a direction perpendicular to the substrate or parallel to the substrate.

18. The dual-band three-dimensional antenna of claim 11, wherein the second radiation unit is disposed in a manner selected from the group consisting of: the second radiation unit is disposed on the same plane with the obliquely extending unit, and the second radiation unit is not disposed on the same plane with the obliquely extending unit.

19. The dual-band three-dimensional antenna of claim 11, wherein the resonant extension unit is further formed with a tongue plate that is disposed extending at a position between the first end and the second end.
